(19) United States
(12) Patent Application Publication
(10) Pub. No.: US 2019/0392594 A1
(43) Pub. Date: Dec. 26, 2019

(54) SYSTEM AND METHOD FOR MAP LOCALIZATION WITH CAMERA PERSPECTIVES

(71) Applicant: Walmart Apollo, LLC, Bentonville, AR (US)

(72) Inventors: John J. O'BRIEN, Farmington, AR (US); Donald R. HIGH, Noel, MO (US); Brian MCHALE, Oldham (GB)

(73) Assignee: Walmart Apollo, LLC, Bentonville, AR (US)

(21) Appl. No.: 16/449,648

(22) Filed: Jun. 24, 2019

Related U.S. Application Data
(60) Provisional application No. 62/689,632, filed on Jun. 25, 2018.

(51) Int. Cl. G06T 7/33; G06T 7/73; G06K 9/22

(52) U.S. Cl. CPC G06T 7/33; G06T 2207/10028; G06K 9/228; G06T 7/73

(57) ABSTRACT

A system includes a point cloud generator configured to generate a point cloud of a store, an imaging data generator configured to generate imaging data of the store, and an analysis module. The analysis module is configured to receive the point cloud and the imaging data; combine the point cloud with the imaging data to generate an overlayed map; add date and time to the overlayed map; establish reference points in the overlayed map; receive an instruction of identifying a desired location in the overlayed map; identify the location in the overlayed map based on the reference points; identify, from the imaging data and based on the date and time, a portion of the imaging data relevant to the location; and analyze the portion of the imaging data to obtain knowledge of events or activities occurring at the location at the date and time.

### CROSS REFERENCE TO RELATED APPLICATION

This patent application claims the benefit of U.S. Provisional Application No. 62/689,632, filed Jun. 25, 2018, the contents of which is incorporated by reference herein.

### BACKGROUND

### 1. Technical Field

The present disclosure relates to imaging technology, and more specifically to systems and methods for map localization with camera perspectives.

### 2. Introduction

A map may be used to identify a location where a particular event or activity may have occurred, for example, at a retail store or at a section of a city street. However, mapping engines may not provide camera perspective view points and orientation with translucent overlays, such that more intuitive insights into the camera's findings and the positioning may be obtained.

There is a need for systems and methods of identifying a location from a map at which an interested event occurred can be analyzed from different perspectives.

### SUMMARY

A system configured as disclosed herein can include: a point cloud generator configured to generate a point cloud of a store, an imaging data generator configured to generate imaging data of the store, and an analysis module. The analysis module is configured to receive the point cloud and the imaging data; combine the point cloud with the imaging data to generate an overlayed map; add date and time to the overlayed map; establish reference points in the overlayed map; receive an instruction of identifying a desired location in the overlayed map; identify the location in the overlayed map based on the reference points; identify, from the imaging data and based on the date and time, a portion of the imaging data relevant to the location; and analyze the portion of the imaging data to obtain knowledge of events or activities occurring at the location at the date and time.

A method for performing concepts disclosed herein can include: generating, by a point cloud generator, a point cloud of a store; generating, by an imaging data generator, imaging data of the store; combing, by an analysis module, the point cloud with the imaging data to generate an overlayed map; adding, by the analysis module, date and time to the overlayed map; establishing, by the analysis module, reference points in the overlayed map; receiving, by the analysis module, an instruction of identifying a desired location in the overlayed map; identifying, by the analysis module, the location in the overlayed map based on the reference points; identifying, by the analysis module, from the imaging data and based on the date and time, a portion of the imaging data relevant to the location; and analyzing, by the analysis module, the portion of the imaging data to obtain knowledge of events or activities occurring at the location at the date and time.

A non-transitory computer-readable storage medium configured as disclosed herein can have instructions stored which, when executed by a computing device, cause the computing device to perform operations which include: generating, by a point cloud generator, a point cloud of a store; generating, by an imaging data generator, imaging data of the store; combing, by an analysis module, the point cloud with the imaging data to generate an overlayed map; adding, by the analysis module, date and time to the overlayed map; establishing, by the analysis module, reference points in the overlayed map; receiving, by the analysis module, an instruction of identifying a desired location in the overlayed map; identifying, by the analysis module, the location in the overlayed map based on the reference points; identifying, by the analysis module, from the imaging data and based on the date and time, a portion of the imaging data relevant to the location; and analyzing, by the analysis module, the portion of the imaging data to obtain knowledge of events or activities occurring at the location at the date and time.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 illustrates an exemplary system of identifying a location and associated imaging data for analyzing activities that have occurred at the location, according to one embodiment of the present disclosure;

FIG. 2 illustrates an exemplary point cloud of a retail store, according to one embodiment of the present disclosure;

FIG. 3 illustrate an exemplary camera footage from camera C point of view of FIG. 2;

FIG. 4 illustrate an exemplary diagram combining the camera footage of camera C with the point cloud;

FIG. 5 illustrates an exemplary method of identifying a location and associated imaging data for analyzing activities that have occurred at the location, according to one embodiment of the present disclosure; and

FIG. 6 illustrates an exemplary computer system that may be used to comprise the above systems in FIGS. 1-4, and to perform the method of FIG. 5.

### DETAILED DESCRIPTION

Systems, methods, and computer-readable storage media configured according to this disclosure are capable of identifying a location and associated imaging data for analyzing from different perspectives activities that have occurred at the location. The disclosed systems, methods, and computer-readable storage media may allow a point cloud (e.g., a navigational map, 3D image of an area), to be combined with one or more camera's perspective and their position. The viewing perspective of imaging data may change based upon the selection of a camera. The point cloud may provide location information associated with the viewing perspective. The two views (camera and point cloud) may be overlayed and dual projected through translucent filters. Additionally, both date and time may be added to the camera's view, the point cloud, or the overlayed view, for further identification and analytics. In some embodiments, multiple cameras and multiple point clouds can be applied in the same system to allow for comprehensive analytics.

As used herein, the “point cloud” may comprise a map for location identification. The “imaging data” may comprise static images and videos captured by an imaging device, such as a camera. The “camera” may comprise a hand-held camera, a robot camera, a mobile camera or a mounted camera.

Various specific embodiments of the disclosure are described in detail below. While specific implementations are described, it should be understood that this is done for illustration purposes only. Other components and configurations may be used without parting from the spirit and scope of the disclosure, and can be implemented in combinations of the variations provided. These variations shall be described herein as the various embodiments are set forth.

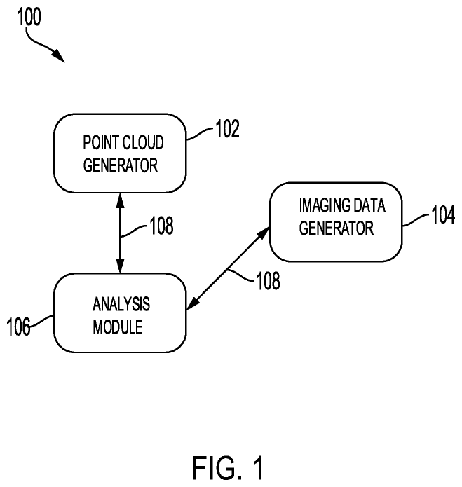

FIG. 1 illustrates an exemplary system 100 of identifying a location and associated imaging data for analyzing activities that have occurred at the location according to one embodiment of the present disclosure. The system 100 may comprise a point cloud generator 102, an image data generator 104, and an analysis module 106. The system 100 may further comprise one or more wired or wireless communication networks 108 through which the point cloud generator 102 and the image data generator may communicate with the analysis module 106.

The point cloud generator 102, the image data generator 104, and the analysis module 106, may each comprise computing hardware, computing software, or a combination thereof to implement the desired functions and features. In addition, the point cloud generator 102, the image data generator 104, and the analysis module 106 may embody a server cluster with each of the point cloud generator 102, the image data generator 104, and the analysis module 106 operates on one server. The point cloud generator 102, the image data generator 104, and the analysis module 106 may embody a cloud computing environment. Further, a portion or whole of the system 100 may be configured to operate by different parties. For example, the point cloud generator 102 may be operated by one vendor who specializes in generating point cloud of buildings, cities, etc. The imaging data generator 104 may be operated by a store in which items may display for sale. And the analysis module 106 may be a cloud computing device.

The point cloud generator 102 may be configured to generate a point cloud of building, for example, a store in which products may be stored or for sale. The point cloud generator 102 may be a 3 dimensional (3D) scanner, or any map-generating device. The point cloud may embody a map, for example, a regular electronic map of a building or an interested area. The point cloud information may be stored for later use once created.

The imaging data generator 104 may be configured to generate imaging data of the store. The imaging generator 104 may be a hand-held imaging device, a robotic imaging device, a closed circuit television (CCTV), or a mounted imaging device, for example, a camera, a smartphone equipped with a camera, a camcorder, etc. The imaging data may comprise static images (pictures) or videos having different perspectives with respect to the store. The imaging data generator 104 may also be configured to receive pictures and videos of the store from online, for example, from social media or cloud storages, and may also perform further processing on those pictures and videos.

The analysis module 106 may be configured to receive the point cloud and the imaging data, and combine the point cloud with the imaging data to generate an overlayed map. For example, the point cloud may be overlayed with the imaging data, or the imaging data may be overlayed with the point cloud, such that the point cloud is associated with the imaging data to gain a view of what happens at a selected location of the store. A user interface may be provided further on the analysis module 106 for a user to provide an input or select a desired location to explore.

The analysis module 106 may further be configured to add date and time to the overlayed map. The date and time may be retrieved from the imaging data to indicate the date and time on which the imaging data is generated or processed.

Reference points in the overlayed map, in the imaging data, or in the point cloud, which can be used to associate the imaging data with the point cloud, may be identified by the analysis module 106. The reference points may comprise any corners within the store, digital major paths of the store, or electronic labels on shelves of the store, corners of shelves, etc.

The analysis module 106 may also be configured to receive an instruction of identifying a desired location in the overlayed map. The instruction may be an input from a user using the user interface, or an application call to the analysis module 106. Once selected, the location in the overlayed map may be identified based on the reference points. The user may also select a date/time of interest.

The analysis module 106 may also be configured to identify, from the imaging data and based on the date and time, a portion of the imaging data relevant to the location. The portion of the imaging data may be analyzed and processed by the analysis module 106 to obtain knowledge or information of events or activities occurring at the location at the date and time.

In some embodiments, the location may be specified a measurement threshold, for example, 1 m, 2 m, or any distance from the exact location. In such way, any imaging data covering the measurement threshold may be used for analysis.

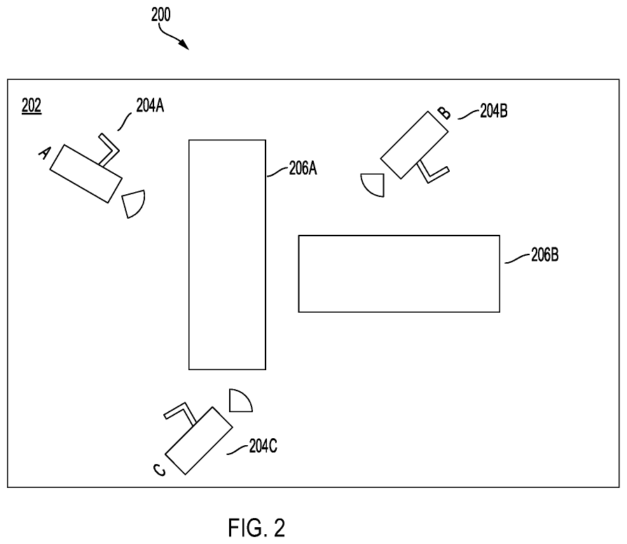

FIG. 2 illustrates an exemplary point cloud 200 of a retail store, according to one embodiment of the present disclosure. The point cloud 200 may comprise a point cloud 202 of the store space, point clouds 204A, 204B and 204C of camera A, camera B, and camera C, respectively which are positioned inside the store from different perspectives or angles. The point cloud 200 may also comprise point clouds 206A and 206B of a vertically positioned shelf and a horizontally positioned shelf, respectively.

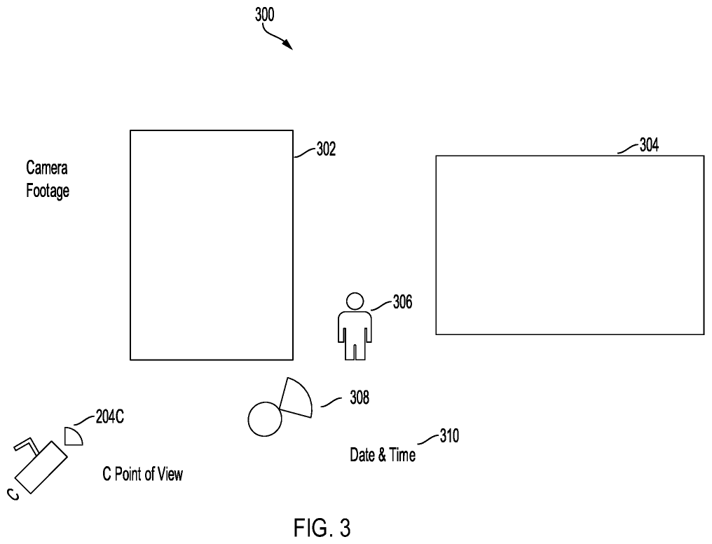

FIG. 3 illustrate an exemplary camera footage 300 from a camera C point of view of FIG. 2. The camera footage 300 may include an image 302, an image 304, a person 306, and an image 308 that may be something dropped or spilled on the floor of the store. The camera footage 300 may further include date and time 310 that indicate when the footage is recorded.

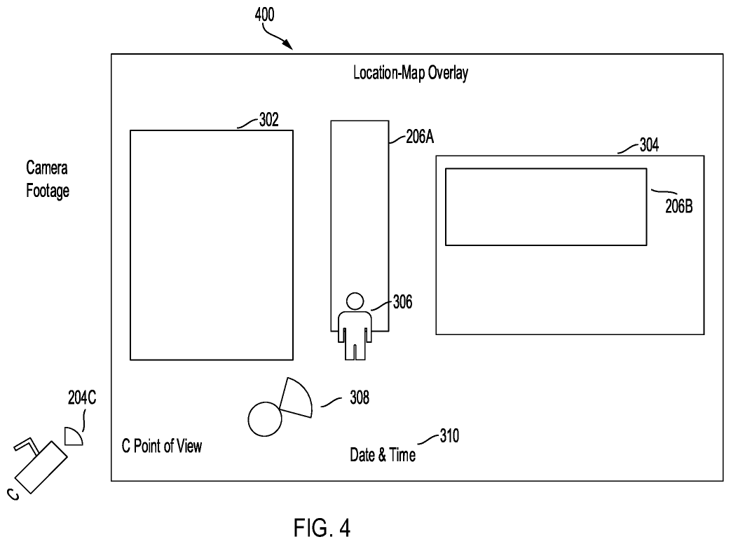

FIG. 4 illustrate an exemplary diagram 400 combining the camera footage 300 of camera C with the point cloud 200. The point cloud 200 may be rotated to the angle or perspective of the camera C to associate with the footage 300 of the camera C. The footage 300 may be underlayed of the point cloud 200 such that the point cloud 200 may show through and the footage 300 may be translucent and viewed in the context of the point cloud 200. In some embodiments, the footage 300 may be overlayed of the point cloud 200 such that the footage 300 may be viewed in the context of the point cloud 200.

In some embodiments, a different video or footage may further be overlayed, for example a camera from another angle or location. Also another object in that area or location may be overlayed to see what it looks and see if traffic would be able to still move around the object.

In some embodiments, to associate the footage 300 with the point cloud 200, reference points may be identified and established in the footage 300 and associated with corresponding points in the point cloud 200. With the reference points established, a specific location may be identified to view what has been going on at that location. In addition, date and time may be also added such that the perspective of the date and time can be analyzed.

In some embodiments, the point cloud 200 and the footage 300 may be generated simultaneously by a comprehensive device or separate devices. In such case, the reference points may be associated with the footage 300 when the point cloud 200 is generated. For example, when a 3D scanner generates the point cloud 200, laser beams may measure distances to find different reference points. The point cloud 200 may be stored in a database once created. Those reference points may be mapped and overlayed with the images of the footage 300 such that those reference points can be seen by a user. A user may further manipulate a wire frame of the point cloud 200 with the images of the footage 300 to associate reference points with the images of the footage 300.

Reference points may also be generated by specifying a point or object and then measuring distances, for example using laser beams.

Once those reference points are established, the footage 300 may be walked through where applied to the point cloud 200. Based on those reference points, a user may know where he is looking at and what he is looking at, and which may be stitched together for a comprehensive analysis. For example, when an interested location is identified based on the reference points, imaging data (static images and videos) attached with date and time and generated at that location may be identified.

The location may have x, y, and z coordinates, each of which may have a threshold (e.g., 1 m, 2 m, etc.), such that the location may comprise a range of area. Imaging data from all the imaging devices located within that range of area at a specific time may be retrieved to analyze activities or events that have occurred at that location at that specific time. In such way, all perspectives of the imaging devices may be utilized to provide an accurate and comprehensive analysis. Further, a specific perspective from a specific camera may also be selected for analyzing a particular activity. For example, an electronic label may need to be checked to see if it works as it is supposed to, a robot may need to be checked to see if it scans what it should scan at this location and at this time, etc.

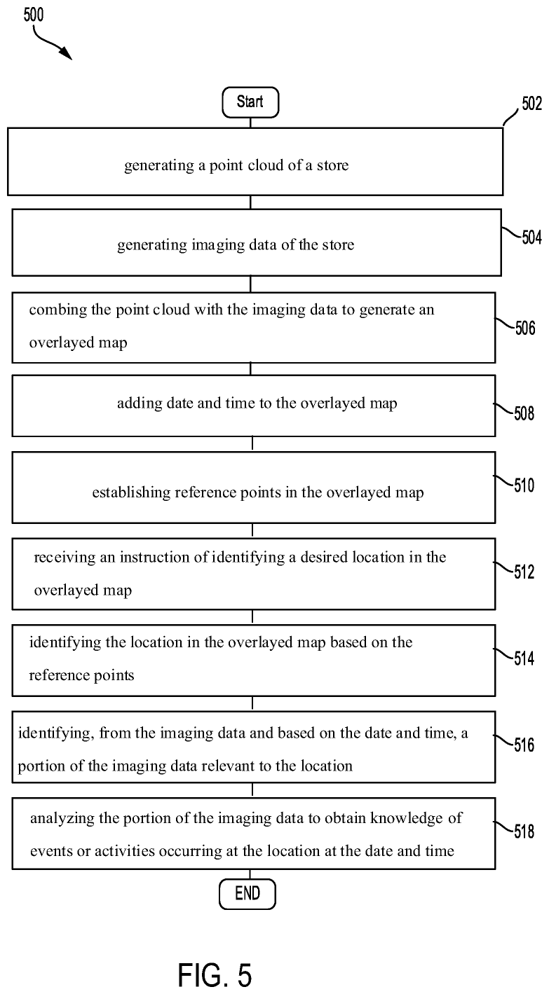

FIG. 5 illustrates an exemplary method 500 of identifying a location and associating imaging data for analyzing activities that have occurred at the location, according to one embodiment of the present disclosure. The method 500 may be implemented in the above disclosed systems, may include the following steps, and thus some details may not be repeated herein that can refer to the above description of the systems.

At step 502, a point cloud of a store is generated. The point cloud may comprise a map and may be generated by a 3D scanner.

At step 504, imaging data of the store is generated. The imaging data may comprise static images (e.g., pictures) and videos having different perspectives with respect to the store. The imaging data may be generated by any imaging devices such as hand-held imaging devices (e.g., smartphones), robot imaging devices, and mounted imaging devices. The imaging data may also be generated by crowdsourcing, such as from social media.

At step 506, the point cloud is combined with the imaging data to generate an overlayed map. The association of the point cloud with the imaging data may be achieved by overlaying the point cloud on the imaging data or underlaying the point cloud under the imaging data.

At step 508, date and time may be added to the overlayed map. The date and time may be used to label when the imaging data is generated.

At step 510, reference points may be established in the overlayed map. The reference points may be first identified in the imaging data. The reference points may also first be identified in the point cloud. The reference points may be used to associate the point cloud with the imaging data, and may also be used to specify an interested location. The reference points may comprise any corners of the store, digital major paths of the store, or electronic labels on shelves of the store.

At step 512, an instruction of identifying a desired location in the overlayed map may be received. The instruction may be received via a user interface, or may be generated by picking up a location in the overlayed map.

At step 514, the desired location in the overlayed map may be identified based on the reference points. The location may be specified a measurement threshold such that a range around the exact location may be formed. The location may be identified by calculating geometric distances based on the reference points.

At step 516, a portion of the imaging data relevant to the location may be identified from the imaging data and based on the date and time. Such identified imaging data may include imaging data captured by all imaging devices from the range about the location at the date and time, from different perspectives.

At step 518, the portion of the imaging data may be analyzed to obtain knowledge of events or activities occurring at the location at the date and time. For example, a person may be identified at the specified location and at the date and time to accidently spill something on the store floor.

The steps may be performed in a different order, combined or omitted. For example, steps 506-510 may be performed after step 514.

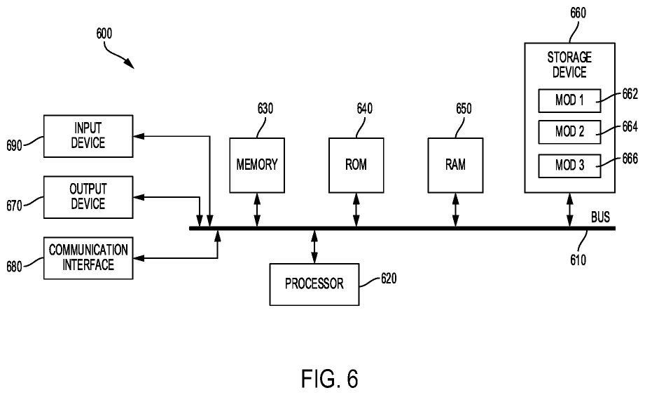

FIG. 6 illustrates an exemplary computer system 600 that may be used to comprise the above systems in FIGS. 1-4, and to perform the method of FIG. 5. The exemplary system 600 can include a processing unit (CPU or processor) 620 and a system bus 610 that couples various system components including the system memory 630 such as read only memory (ROM) 640 and random access memory (RAM) 650 to the processor 620. The system 600 can include a cache of high speed memory connected directly with, in close proximity to, or integrated as part of the processor 620. The system 600 copies data from the memory 630 and/or the storage device 660 to the cache for quick access by the processor 620. In this way, the cache provides a performance boost that avoids processor 620 delays while waiting for data. These and other modules can control or be configured to control the processor 620 to perform various actions. Other system memory 630 may be available for use as well. The memory 630 can include multiple different types of memory with different performance characteristics. It can be appreciated that the disclosure may operate on a computing system 600 with more than one processor 620 or on a group or cluster of computing devices networked together to provide greater processing capability. The processor 620 can include any general purpose processor and a hardware module or software module, such as module 1 662, module 2 664, and module 3 666 stored in storage device 660, configured to control the processor 620 as well as a special-purpose processor where software instructions are incorporated into the actual processor design. The processor 620 may essentially be a completely self-contained computing system, containing multiple cores or processors, a bus, memory controller, cache, etc. A multi-core processor may be symmetric or asymmetric.

The system bus 610 may be any of several types of bus structures including a memory bus or memory controller, a peripheral bus, and a local bus using any of a variety of bus architectures. A basic input/output (BIOS) stored in ROM 640 or the like, may provide the basic routine that helps to transfer information between elements within the computing system 600, such as during start-up. The computing system 600 further includes storage devices 660 such as a hard disk drive, a magnetic disk drive, an optical disk drive, tape drive or the like. The storage device 660 can include software modules 662, 664, 666 for controlling the processor 620. Other hardware or software modules are contemplated. The storage device 660 is connected to the system bus 610 by a drive interface. The drives and the associated computer-readable storage media provide nonvolatile storage of computer-readable instructions, data structures, program modules and other data for the computing system 600. In one aspect, a hardware module that performs a particular function includes the software component stored in a tangible computer-readable storage medium in connection with the necessary hardware components, such as the processor 620, bus 610, output device 670 as display, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the system 600 is a small, handheld computing device, a desktop computer, or a computer server.

Although the exemplary embodiment described herein employs the hard disk as the storage device 660, other types of computer-readable media which can store data that are accessible by a computer, such as magnetic cassettes, flash memory cards, digital versatile disks, cartridges, random access memories (RAMs) 650, and read only memory (ROM) 640, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing system 600, an input device 690 represents any number of input mechanisms, such as a microphone for speech, a touch-sensitive screen for gesture or graphical input, keyboard, mouse, motion input, speech and so forth. An output device 670 can also be one or more of a number of output mechanisms known to those of skill in the art. In some instances, multimodal systems enable a user to provide multiple types of input to communicate with the computing system 600. The communications interface 680 generally governs and manages the user input and system output. There is no restriction on operating on any particular hardware arrangement and therefore the basic features here may easily be substituted for improved hardware or firmware arrangements as they are developed.

The concepts disclosed herein can also be used to improve the computing systems which are performing, or enabling the performance, of the disclosed concepts. For example, the imaging data is timestamped so that only the imaging data generated at that time or at a time frame may be analyzed, instead of all the imaging data. Similarly, only the imaging data that is relevant to a location may be identified and used for analysis. In such way, computing resources consumption can be significantly reduced to improve computing efficiency. Further, by using imaging data from different perspectives, computing accuracy can be significantly improved.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A system, comprising:
a point cloud generator configured to generate a point cloud of a store;
an imaging data generator configured to generate imaging data of the store; and
an analysis module configured to:
receive the point cloud and the imaging data;
combine the point cloud with the imaging data to generate an overlayed map;
add date and time to the overlayed map;
establish reference points in the overlayed map;
receive an instruction of identifying a desired location in the overlayed map;
identify the location in the overlayed map based on the reference points;
identify, from the imaging data and based on the date and time, a portion of the imaging data relevant to the location; and
analyze the portion of the imaging data to obtain knowledge of events or activities occurring at the location at the date and time.

2. The system of claim 1, wherein the point cloud generator is a 3D scanner.

3. The system of claim 1, wherein the point cloud comprises a map.

4. The system of claim 1, wherein the imaging data comprises static images or videos having different perspectives with respect to the store.

5. The system of claim 1, where the imaging generator is a hand-held imaging device, a robotic imaging device, or a mounted imaging device.

6. The system of claim 1, wherein the analysis module is further configured to generate the overlayed map by overlaying the point cloud on the imaging data.

7. The system of claim 1, wherein the analysis module is further configured to generate the overlayed map by overlaying the imaging data on the point cloud.

8. The system of claim 1, wherein the reference points comprises any corners of the store, digital major paths of the store, or electronic labels on shelves of the store.

9. The system of claim 1, wherein the location is specified a measurement threshold.

10. A method, comprising:
generating, by a point cloud generator, a point cloud of a store;
generating, by an imaging data generator, imaging data of the store;
combing, by an analysis module, the point cloud with the imaging data to generate an overlayed map;
adding, by the analysis module, date and time to the overlayed map;
establishing, by the analysis module, reference points in the overlayed map;
receiving, by the analysis module, an instruction of identifying a desired location in the overlayed map;
identifying, by the analysis module, the location in the overlayed map based on the reference points;
identifying, by the analysis module, from the imaging data and based on the date and time, a portion of the imaging data relevant to the location; and
analyzing, by the analysis module, the portion of the imaging data to obtain knowledge of events or activities occurring at the location at the date and time.

11. The system of claim 10, wherein the point cloud is generated by a 3D scanner.

12. The system of claim 10, wherein the point cloud comprises a map.

13. The system of claim 10, wherein the imaging data comprises static images or videos having different perspectives with respect to the store.

14. The system of claim 10, where the imaging data is generated by a hand-held imaging device, a robotic imaging device, or a mounted imaging device.

15. The system of claim 10, further comprising generating the overlayed map by overlaying the point cloud on the imaging data.

16. The system of claim 10, further comprising generating the overlayed map by overlaying the imaging data on the point cloud.

17. The system of claim 10, wherein the reference points comprises any corners of the store, digital major paths of the store, or electronic labels on shelves of the store.

18. The system of claim 10, wherein the location is specified a measurement threshold.

19. A non-transitory computer-readable storage medium having instructions stored which, when executed by a computing device, cause the computing device to perform operations comprising:
Generating, by a point cloud generator, a point cloud of a store;
Generating, by an imaging data generator, imaging data of the store; and
combing, by an analysis module, the point cloud with the imaging data to generate an overlayed map;
adding, by the analysis module, date and time to the overlayed map;
establishing, by the analysis module, reference points in the overlayed map;
receiving, by the analysis module, an instruction of identifying a desired location in the overlayed map;
identifying, by the analysis module, the location in the overlayed map based on the reference points;
identifying, by the analysis module, from the imaging data and based on the date and time, a portion of the imaging data relevant to the location; and
analyzing, by the analysis module, the portion of the imaging data to obtain knowledge of events or activities occurring at the location at the date and time.

20. The system of claim 19, wherein the point cloud is generated by a 3D scanner.
